(19) United States
(12) Patent Application Publication
(10) Pub. No.: US 2017/0136566 A1
(43) Pub. Date: May 18, 2017

(54) POWER INTERCONNECTS IN A MODULAR ACCESS PANEL

(71) Applicant: Illinois Tool Works Inc., Glenview, IL (US)

(72) Inventors: Nicholas James Dessart, Appleton, WI (US); Michael Allen Sammons, Appleton, WI (US)

(21) Appl. No.: 14/943,230

(22) Filed: Nov. 17, 2015

(51) Int. Cl. B23K 9/10; H01R 4/34; H01R 4/64

(52) U.S. Cl. CPC B23K 9/1006; H01R 4/64; H01R 4/34

(57) ABSTRACT

A bolt-through type power connector includes a metal plate portion and a metal attachment portion. The bolt-through type power connector has a first end and a second end. The bolt-through type power connector includes a metal plate portion at the first end. The metal plate portion includes a structure that is configured to support one or more ring terminals of one or more power cables. The structure is (a) a through hole, which is in the metal plate portion and sized to receive a bolt that is configured to support the one or more ring terminals, or (b) a stud, which is configured to support the one or more ring terminals. The metal attachment portion extends from the metal plate portion to the second end. The metal attachment portion has a male engagement portion with a flange portion that provides a surface facing the second end. The male engagement portion has an outer profile for receipt of hardware to secure the bolt-through type connector within an opening of a bulkhead assembly. The bolt-through type power connector is structured to effectively carry a current that is equal to or greater than 450 amperes.

### TECHNICAL FIELD

The present disclosure relates generally to systems and methods involving power interconnects in a modular access panel.

### BACKGROUND

There are various applications that require various current capabilities. For example, in one instance, a high amperage current may be necessary to perform a certain task, whereas, in another instance, a low amperage current may be necessary to perform another task. Although the power source itself may be configured to accommodate various amperage applications, the ability to utilize these different current capabilities may be limited by the connections that are made to the power source.

For example, in the field of welding systems, a typical welding apparatus may include a connector, which mates with a single power cable and which connects to a power source. Typically, the connector may be a twist-lock type power connector that is configured to connect to a single power cable. However, since only a single power cable is configured to connect to the power source via the twist-lock type power connector, such a welding apparatus is limited as to the amount of current that can be utilized in connection with this power source.

### SUMMARY

The systems and methods described herein attempt to cure the deficiencies of conventional systems by providing what is referred to herein as a bolt-through type power connector. The bolt-through type power connector is structured to accommodate various electrical coupling configurations and current capacities with respect to at least one power source. The bolt-through type power connector is compatible with mounting mechanisms of a twist-lock type power connector. This feature enables the bolt-through type power connector to be interchangeable with a twist-lock type power connector. The interchangeability of these power connectors is advantageous, as it allows for current capabilities to be modified in a relatively seamless manner.

The systems and methods described herein enable a greater range of amperage levels of at least one power source to be utilized with relative ease. In this regard, a bolt-through type power connector is able to provide these various amperage levels by being configured to electrically connect to a single power cable or a plurality of power cables. With the systems and methods described herein, a user is able to switch between a relatively low amperage capacity, as carried by a single power cable, to a relatively high amperage capacity, as carried by a plurality of power cables, or vice versa. The transition from a single power cable to a plurality of power cables (or vice versa) involves a simple action of connecting and/or disconnecting the requisite power cables to/from the bolt-through type power connector via a stud or a mechanical fastener (e.g., bolt and nut).

In an embodiment, a bolt-through type power connector includes a metal plate portion and a metal attachment portion. The bolt-through type power connector has a first end and a second end. The bolt-through type power connector includes a metal plate portion at the first end. The metal plate portion includes a structure that is configured to support one or more ring terminals of one or more power cables. The structure is (a) a through hole, which is in the metal plate portion and sized to receive a bolt that is configured to support the one or more ring terminals, or (b) a stud, which is configured to support the one or more ring terminals. The metal attachment portion extends from the metal plate portion to the second end. The metal attachment portion has a male engagement portion with a flange portion that provides a surface facing the second end. The male engagement portion has an outer profile for receipt of hardware to secure the bolt-through type power connector within an opening of a bulkhead assembly. The bolt-through type power connector is structured to effectively carry a current that is equal to or greater than 450 amperes.

In an embodiment, a modular access panel includes a mounting plate. A bulkhead assembly is mounted on the mounting plate. A bolt-through type power connector is inserted in the bulkhead assembly. The bolt-through type power connector has first and second ends. The bolt-through type power connector includes a metal plate portion and a metal attachment portion. The metal plate portion is at the first end of the bolt-through type power connector. The metal plate portion includes a structure that is configured to support one or more ring terminals of one or more power cables. The structure is (a) a through hole, which is in the metal plate portion and sized to receive a bolt that is configured to support the one or more ring terminals, or (b) a stud, which is configured to support the one or more ring terminals. The metal attachment portion extends from the metal plate portion to the second end. The metal attachment portion has a male engagement portion with a flange portion that provides a surface facing the second end. The male engagement portion has an outer profile for receipt of hardware to secure the bolt-through type power connector within an opening of the bulkhead assembly. The bolt-through type power connector is structured to effectively carry a current that is equal to or greater than 450 amperes.

In an embodiment, a welding system includes a power source, a modular access panel, a bulkhead assembly, and a bolt-through type power connector. The modular access panel has a mounting plate. The bulkhead assembly is mounted on the mounting plate. The bolt-through type power connector is inserted in the bulkhead assembly and connected to the power source. The bolt-through type power connector has first and second ends. The bolt-through type power connector includes a metal plate portion and a metal attachment portion. The metal plate portion includes a structure that is configured to support one or more ring terminals of one or more power cables. The structure is (a) a through hole, which is in the metal plate portion and sized to receive a bolt that is configured to support the one or more ring terminals, or (b) a stud, which is configured to support the one or more ring terminals. The metal attachment portion extends from the metal plate portion to the second end. The metal attachment portion has a male engagement portion with a flange portion that provides a surface facing the second end. The male engagement portion has an outer profile for receipt of hardware to secure the bolt-through type power connector within an opening of a bulkhead assembly. The bolt-through type power connector is structured to effectively carry a current that is equal to or greater than 450 amperes.

Additional features and advantages of exemplary embodiments will be set forth in the description which follows, and in part will be apparent from the description. The objectives and advantages of the invention will be realized and attained by the structure particularly pointed out in the exemplary embodiments in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The preferred embodiments of the present invention are illustrated by way of example and not limited to the following figures:

FIG. 1 illustrates a welding system according to an exemplary embodiment.

FIG. 2 illustrates a modular access panel according to an exemplary embodiment.

FIGS. 3A and 3B illustrate bolt-through type power connectors according to exemplary embodiments.

FIGS. 4A and 4B illustrate a bolt-through type power connector before and after installation according to an exemplary embodiment.

FIG. 5 illustrates a modular access panel and a bulkhead assembly together with a twist-lock type power connector according to an exemplary embodiment.

FIGS. 6A and 6B illustrate a bolt-through type power connector together with a single power cable according to an exemplary embodiment.

FIGS. 7A and 7B illustrate a bolt-through type power connector together with a plurality of power cables according to an exemplary embodiment.

FIGS. 8A and 8B illustrate a bolt-through type power connector together with a plurality of power cables according to an exemplary embodiment.

### DETAILED DESCRIPTION

Various embodiments and aspects of the invention will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

The systems and methods described herein relate to interchangeable power connectors in a modular access panel with respect to at least one power source. The systems and methods are described in detail below.

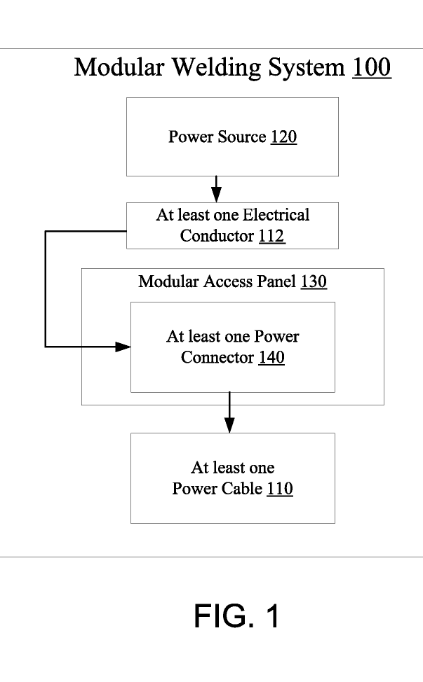

Referring generally to FIG. 1, a welding system 100 according to an exemplary embodiment is illustrated. Welding system 100 preferably is a Continuum® welding machine available from Miller Welding Systems. Alternatively, welding system 100 may be any industrial welding system or non-industrial welding system. In FIG. 1, the illustration of welding system 100 has been simplified in order to focus on the depiction of at least one power connection point. Obviously, welding system 100 includes other elements, which are known in the art and not shown.

As mentioned above, welding system 100 includes at least one power connection point. Power connection point may be a primary welding power connection point or a secondary welding power connection point. Power connection point may be associated with at least one power cable 110 connected to at least one power source 120 via at least one electrical conductor 112. Power connection point may provide output welding power via power cable 110. Power source 120 may be a constant voltage (CV), a constant current (CC), a constant current/constant voltage (CC/CV), an alternating current (AC), a direct current (DC), a combination AC/DC source, or any suitable type of power supply for welding system 100. Power source 120 may supply various amperages. Power cable 110 may be a thermal set hose, a copper braided cable, any type of welding cable, or any other suitable power transmission means. Power cable 110 may provide electrical power to a welding device, such as a welding torch. Electrical conductor 112 may be a bus bar, a power cable, any suitable power transmission means, or a combination thereof.

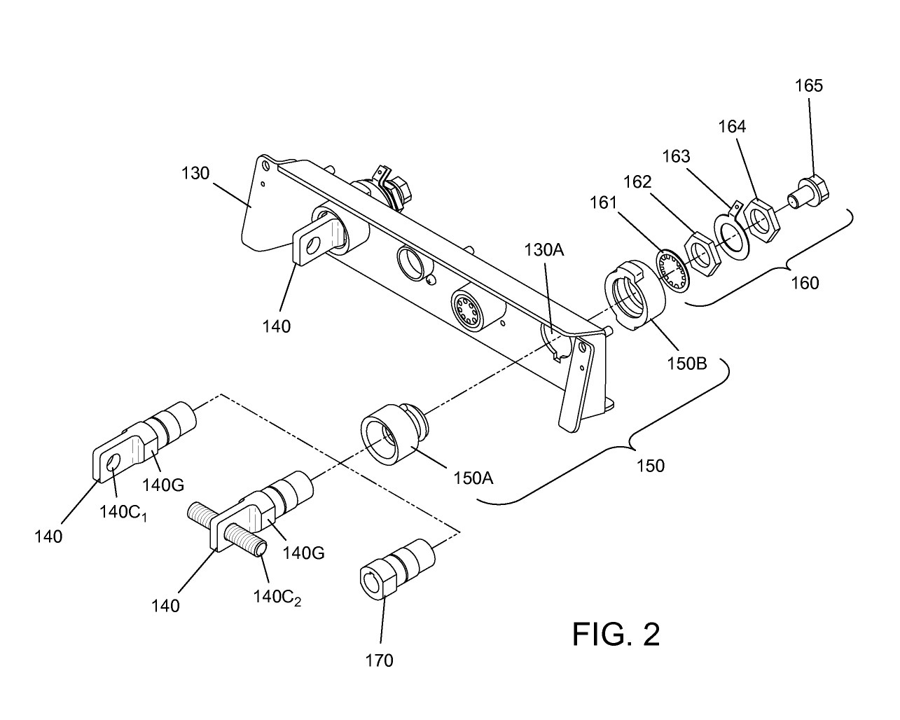

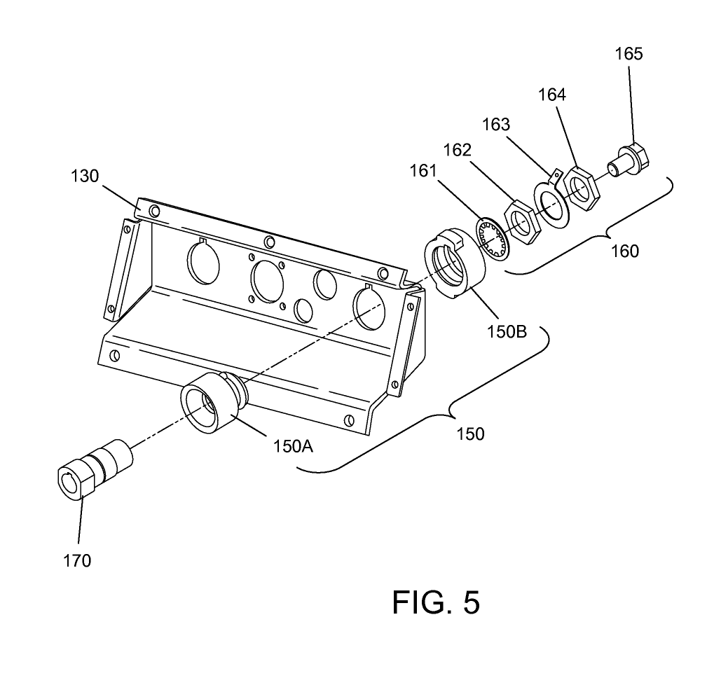

Welding system 100 may include modular access panel 130. Modular access panel 130 may be separated and/or combined with one or more units that houses welding system 100. Modular access panel 130 comprises aluminum, steel, plastic, or any suitable material. Modular access panel 130 may be a mounting plate, which is configured to function as an interface for the user. Modular access panel 130 may include a plurality of mounting mechanisms by which various welding system 100 components may be mounted. For example, modular access panel 130 may include a means by which different welding connections may be mounted thereon. FIG. 2 illustrates one example of modular access panel 130 while FIGS. 5-7B illustrate another example of modular access panel 130. As demonstrated by these examples, modular access panel 130 is not particularly limited in certain design aspects so long as modular access panel 130 is configured to provide at least a suitable interface together with proper mounting and functionality, as discussed herein.

Referring generally to FIG. 2, modular access panel 130 is illustrated according to one exemplary embodiment. Modular access panel 130 has at least one through hole 130A that may be used to install at least one power connector holder 150 thereon. As shown, through hole 130A is sized and shaped to receive a portion of power connector holder 150 therethrough. Power connector holder 150 and power connector 140 or 170 are installed on modular access panel 130 before being connected to power source 120. Power connector holder 150 may comprise a bulkhead assembly or any suitable mechanism that enables power connector 140 or 170 to be mounted to modular access panel 130.

As shown, power connector holder 150 comprises a bulkhead assembly, which includes a front insulator bulkhead 150A and a rear insulator bulkhead 150B. Front insulator bulkhead 150A and the rear insulator bulkhead 150B may comprise the same materials or different materials. Front insulator bulkhead 150A may comprise an insulator, such as thermal set plastic, ceramic, or any suitable material. Rear insulator bulkhead 150B may comprise an insulator, such as a thermal set plastic, ceramic, or any other suitable material.

In one embodiment, front insulator bulkhead 150A may be mounted to a front side of the modular access panel 130. Rear insulator bulkhead 150B may be mounted to a rear side of the modular access panel 130. Front insulator bulkhead 150A is configured to mate with rear insulator bulkhead 150B. More specifically, a back-end portion of front insulator bulkhead 150A is configured to fit into a front-end portion of rear insulator bulkhead 150B.

Front insulator bulkhead 150A may be securely attached to rear insulator bulkhead 150B. To provide this secure attachment, front insulator bulkhead 150A may include an outer profile that comprises grooves, indentations, projections, threads, any suitable structure, or any combination thereof. Front insulator bulkhead 150A may have at least a portion with an outer surface that comprises this profile. In addition, rear insulator bulkhead 150B may include an inner profile that comprises mating grooves, indentations, projections, threads, any suitable structure, or any combination thereof. Rear insulator bulkhead 150B may have a portion with an inner surface that comprises this profile. The inner profile of rear insulator bulkhead 150B is configured such that at least a portion thereof securely mates with the outer profile of the front insulator bulkhead 150A. For example, front insulator bulkhead 150A may have a back-end portion with a profile on an outer surface thereof that mates with a profile on an inner surface of a front-end portion of the rear insulator bulkhead 150B.

The mating of front insulator bulkhead 150A and rear insulator bulkhead 150B allows their center portions to be aligned along a longitudinal direction. When joined, front insulator bulkhead 150A and rear insulator bulkhead 150B comprise a power connector holder 150 or power connector receiving portion 150. Power connector holder 150 is configured to receive a respective section of power connector 140 or 170 that is inserted therein. To that end, power connector holder 150 may comprise a female engagement portion, which is structured to securely receive twist-lock type power connector 170 or bolt-through type power connector 140. In addition, power connector holder 150 may include at least a portion with an anti-rotational mechanism or feature. For example, with regard to an anti-rotational mechanism or feature, power connector receiving portion 150 may comprise at least a portion that includes a substantially circular shape having two oppositely facing flat sides in cross section to receive power connector 140 or 170. As another example, power connector receiving portion 150 may comprise at least a portion that includes a hexagonal shape in cross section to receive power connector 140 or 170. Power connector holder 150 is not limited to the above-mentioned anti-rotational devices, but may include any suitable anti-rotational mechanism and/or feature.

Twist-lock type power connector 170 is configured to mate with power connector holder 150 by a twist-connect or twist-lock type mechanism. Twist-lock type power connector 170 is configured to connect with a power cable 110 by twisting a cable plug part of the twist-lock type power connector 170 into a cable socket part of the twist-lock type power connector 170. For example, twist-lock type power connector 170 may be a DINSE® connector. Alternatively, twist-lock type power connector 170 may be a Tweco® connector. However, each of these twist-lock type power connectors 170 is typically configured to connect to a single power cable 110 at a given time and is usually rated to provide a current capacity equal to or less than 450 amperes.

Bolt-through type power connector 140 is configured to support a greater range of current capacities than that of the twist-lock type power connector 170 discussed above. Bolt-through type power connector 140 is configured by way of suitable sizing and materials, such as a non-ferrous conductive metal or metals, to accommodate a current capacity equal to or less than 450 amperes. For example, bolt-through type power connector 140 is configured to support a single power cable 110 and a current capacity of 450 amperes or a current capacity less than 450 amperes.

Additionally or alternatively, bolt-through type power connector 140 is configured by way of suitable sizing and materials, such as a non-ferrous conductive metal or metals, to accommodate a current capacity of 450 amperes or a current capacity greater than 450 amperes. For example, bolt-through type power connector 140 is configured to electrically connect multiple ring terminals to power source 120. In the field of welding systems, the use of multiple ring terminals is particularly advantageous when welding or cutting at high amperage.

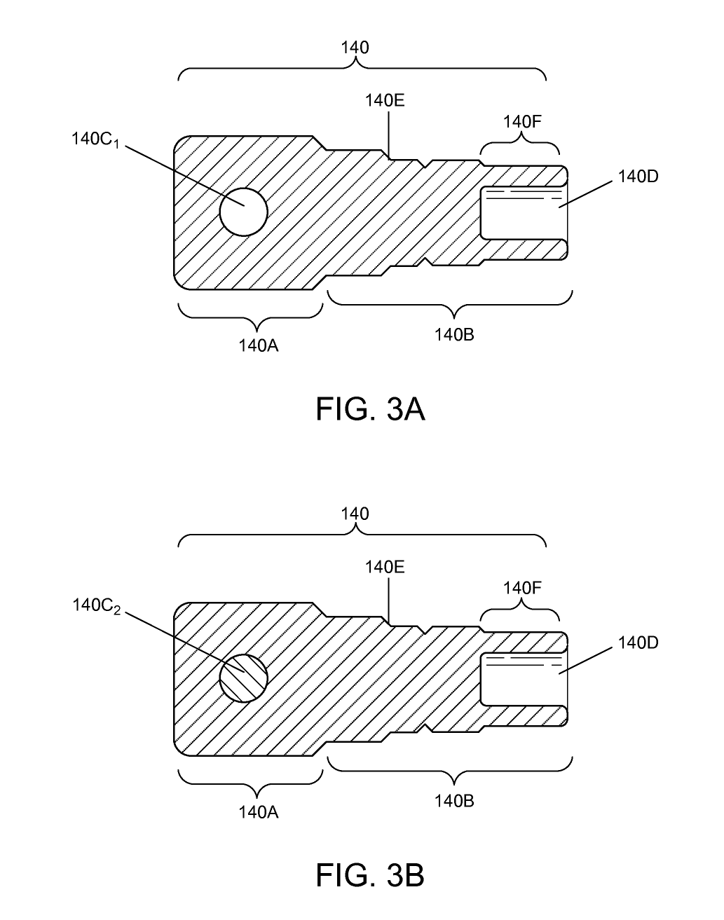

Referring generally to FIGS. 3A and 3B, bolt-through type power connectors 140 are illustrated according to exemplary embodiments. As mentioned, bolt-through type power connector 140 is configured to mate with power connector holder 150. In addition, bolt-through type power connector 140 is configured to fit securely within power connector holder 150 such that bolt-through type power connector 140 does not rotate within power connector holder 150. In this regard, bolt-through type power connector 140 may include at least a portion with an anti-rotational mechanism or feature to prevent a movement of the bolt-through type power connector 140 within power connector holder 150. For example, bolt-through type power connector 140 may include at least an anti-rotational portion 140G that includes a substantially circular shape having two oppositely facing flat sides in cross section. As another example, bolt-through type power connector 140 may comprise at least a portion that includes a hexagonal shape in cross section. Bolt-through type power connector 140 is not limited to the above-mentioned anti-rotational devices, but may include any suitable anti-rotational mechanism and/or feature. Furthermore, the anti-rotational mechanism of bolt-through type power connector 140 may cooperate or engage with the anti-rotational mechanism of power connector holder 150 such that bolt-through type power connector 140 is securely fitted within power connector holder 150 and does not move within power connector holder 150.

More specifically, bolt-through type power connector 140 has a power cable connection portion 140A and an attachment portion 140B. Power cable connection portion 140A and attachment portion 140B may be a unitary body, as shown. Alternatively, power cable connection portion 140A and attachment portion 140B may be separable into a plurality of pieces while being structured to join together in a secure fashion. For example, power cable connection portion 140A could terminate in a male threaded member that engages a female threaded opening at an end of attachment portion 140B.

Power cable connection portion 140A preferably has an outer profile that is substantially rectangular or square in cross-section, as shown in FIGS. 3A-3B, 4A-4B, 6A-6B, and 7A-7B. Power cable connection portion 140A comprises a metal piece. The metal piece may comprise a metal plate or a metal plate-like structure. As other examples, power cable connection portion 140A may comprise a shape as shown in FIG. 2. Other shapes, such as a circular, roundish, or angular type shapes, are acceptable so long as they can effectively handle the required amperages. In addition, as shown in FIGS. 3A-3B, power cable connection portion 140A may be wider in cross-section than that of attachment portion 140. Also, power cable connection portion 140A is sized and shaped appropriately not to exceed its maximum temperature rating.

As mentioned, power cable connection portion 140A is mechanically and electrically structured to support one or more power cables 110. Power cable connection portion 140A may include a suitable structure to achieve this effect. For example, in one embodiment, the structure is a through hole 140C₁, as shown in at least FIGS. 2, 3A, and 4A-7B. In another embodiment, the structure is a stud 140C₂, as shown in at least FIGS. 2, 3B, and 8A-8B. Each of these structural configurations of power cable connection portion 140A is discussed in greater detail below.

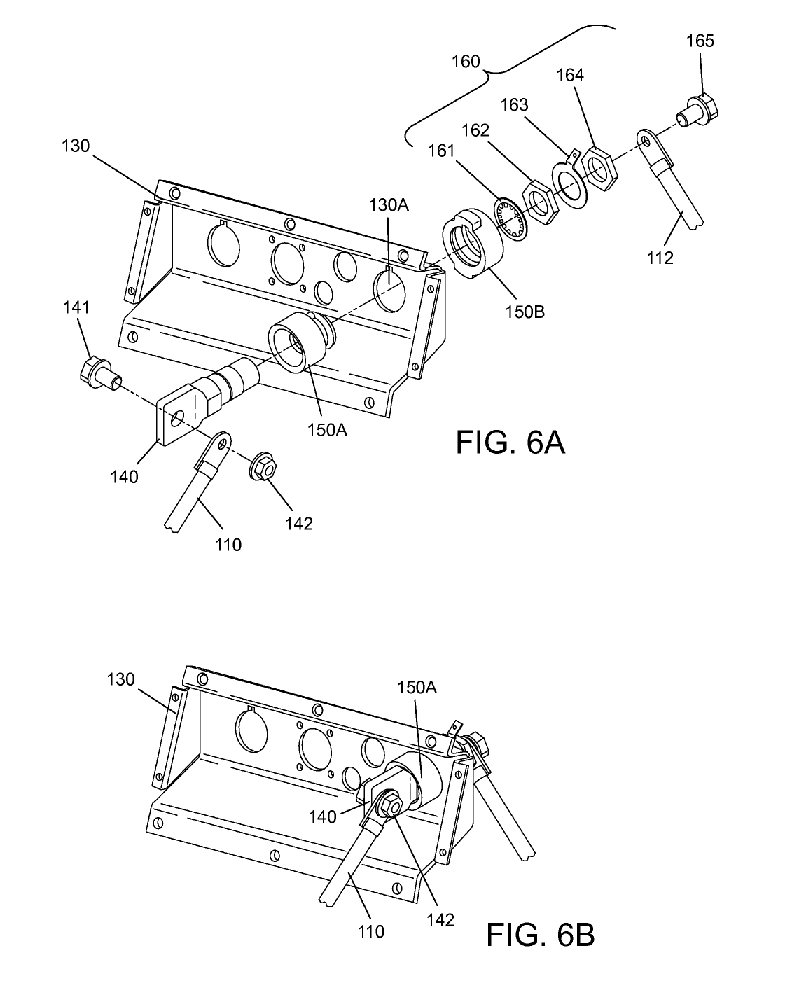

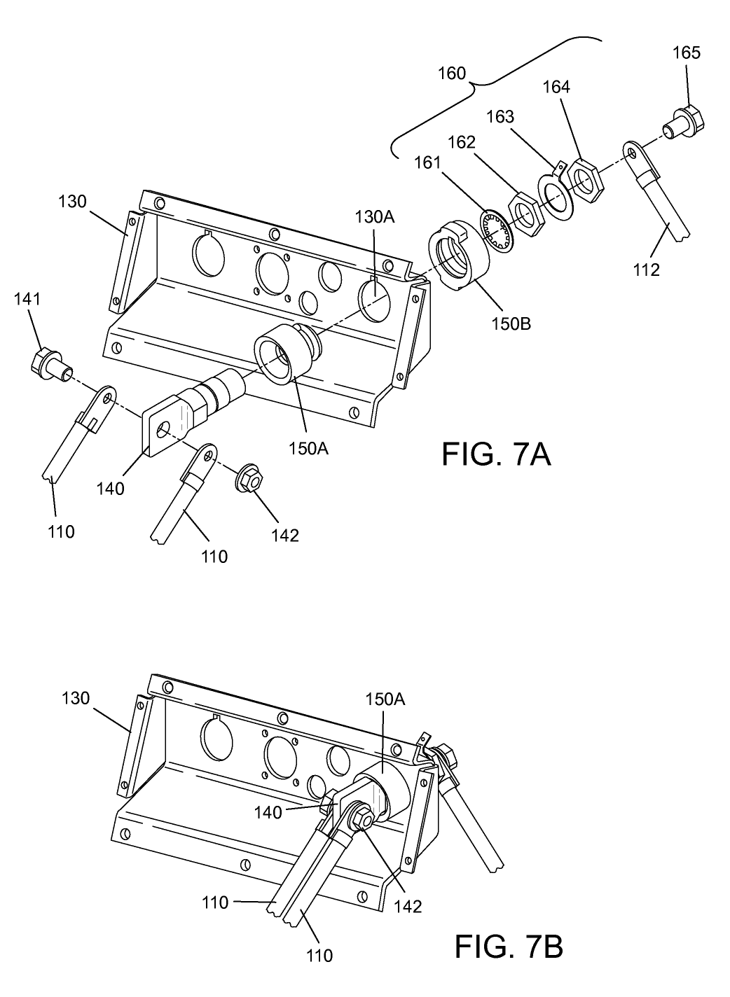

In the first structural configuration, as shown in FIGS. 2, 3A, 4A-4B, and 6A-7B, power cable connection portion 140A may include through hole 140C₁. Through hole 140C₁ is sized to receive a bolt 141 and nut 142, as illustrated in FIG. 6A and FIG. 7A. Bolt 141 is sized to receive one or more ring terminals of one or more power cables 110 thereon. In this regard, through hole 140C₁ is sized and configured adequately to allow proper torque to bolt 141 and nut 142 that will produce a safe clamping force to a single power cable 110 and/or a plurality of power cables 110. Through hole 140C₁ is sized within power cable connection portion 140A such that the current carrying capability of power cable connection portion 140A and/or bolt-through type power connector 140 is not compromised.

Bolt 141 and nut 142 are configured to secure a single power cable 110 and/or a plurality of power cables 110 to power cable connection portion 140A, as illustrated in FIG. 6B and FIG. 7B. Since bolt-through type power connector 140 is able to connect to a single power cable 110 and/or a plurality of power cables 110, bolt-through type power connector 140 is able to support a greater range of amperages than that of twist-lock type power connector 170.

In the second structural configuration, as shown in FIGS. 2, 3B, and 8A-8B, power cable connection portion 140A may include at least one stud 140C₂ that projects outward from at least one surface of the power cable connection portion 140A. In the illustrated embodiment, bolt-through type power connector 140 includes a stud 140C₂ projecting from each main surface of power cable connection portion 140A. Stud 140C₂ may comprise a same material composition of power cable connection portion 140A, power attachment portion 140B, bolt-through type power connector 140, bolt 141, or any combination thereof. Stud 140C₂ may comprise a different material composition of power cable connection portion 140A, attachment portion 140B, bolt-through type power connector 140, bolt 141, or any combination thereof as long as stud 140C₂ is enabled to receive, support, and connect on or more power cables 110 to bolt-through type power connector 140. Stud 140C₂ and power cable connection portion 140A may comprise a unitary body. Also, bolt-through type power connector 140 and stud 140C₂ may be integrally formed to comprise a unitary body.

In the alternative, stud 140C₂ may be separate and distinct from power cable connection portion 140A and/or bolt-through type power connector 140 as long as stud 140C₂ is enabled to mechanically and electrically support one or more power cables 110 in connection with bolt-through type power connector 140. In this regard, when configured as a separate member, stud 140C₂ may be securely attached to power cable connection 140A by a suitable means. For example, stud 140C₂ may be welded onto power cable connection portion 140A. As another example, stud 140C₂ may be securely attached to power cable connection portion 140 by mechanical fasteners.

Stud 140C₂ is sized to receive and support one or more ring terminals of one or more power cables 110. Stud 140C₂ may be threaded or may include a threaded portion. This threaded feature enables the one or more ring terminals to be securely attached to stud 140C₂ by at least one mechanical fastener such as nut 142. In this regard, bolt-through type power connector 140 is structured to allow proper torque to stud 140C₂ and nut 142 that will produce a safe clamping force to a single power cable 110 and/or a plurality of power cables 110. Stud 140C₂ is not limited to threads and nut 142. Additionally or alternatively, stud 140C₂ may include other equivalent and/or suitable mechanical features that enable the one or more power cables 110 to be securely attached.

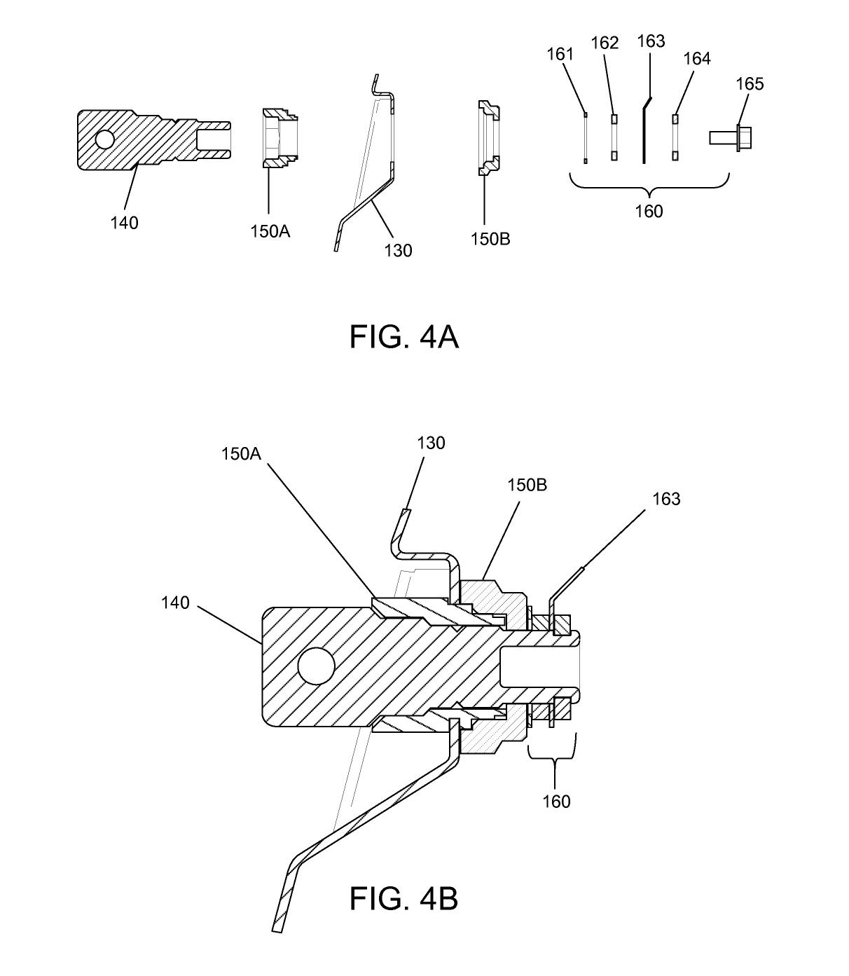

Attachment portion 140B includes a male engagement portion, which is structured to mate with female engagement portion of power connector holder 150, and a connection portion 140F to which at least one electrical conductor 112, such as an incoming power cable, can be attached. More specifically, an outer surface of the attachment portion 140B of bolt-through type power connector 140 has a profile that mates with that of an inner surface of bulkhead assembly 150. Importantly, attachment portion 140B includes a flange portion 140E that functions as a stopper against a mating portion of front insulator bulkhead 150A, as made clear in FIGS. 3A-4B.

Also, connection portion 140F preferably includes a threaded hole 140D at a power source end thereof. This threaded hole 140D is sized to receive bolt 165, which supports the attachment of at least one electrical conductor 112, such as an incoming power cable, to bolt-through type power connector 140. Connection portion 140F also preferably includes a threaded outer surface to receive mounting hardware 160, such as nuts, to secure bolt-through type power connector 140 in the modular access panel 130, as shown in greater detail in FIG. 4A and FIG. 4B.

When bolt-through type power connector 140 comprises power cable connection portion 140A and attachment portion 140B as a unitary member, bolt-through type power connector 140 may comprise a same material for both portions. As another example, bolt-through type power connector 140 may comprise a single material (i.e., a same material composition) even when it is constructed from multiple pieces.

Alternatively, bolt-through type power connector 140 may comprise a plurality of materials. For example, bolt-through type power connector 140 may comprise one or more materials, but is further plated with one or more materials. Additionally or alternatively, power cable connection portion 140A of the bolt-through type power connector 140 may comprise one or more materials while attachment portion 140B of the bolt-through type power connector 140 may comprise one or more materials.

As discussed above, bolt-through type power connector 140 may comprise a single material or a plurality of materials. Bolt-through type power connector 140 may comprise a non-ferrous conductive metal. Bolt-through type power connector 140 may comprise copper or an alloy thereof. Bolt-through type power connector 140 may comprise aluminum or an alloy thereof. Bolt-through type power connector 140 may comprise zinc or an alloy thereof. Bolt-through type power connector 140 may comprise brass, which may be a preferable material in terms of cost.

A series of tests were conducted to ensure that bolt-through type power connector 140 could properly and safely handle a high amperage load, such as a current capacity equal to or greater than 450 amperes. For example, bolt-through type power connector 140, when made of brass, was able to safely handle a load of at least 650 amperes. Based on these tests, the above-mentioned materials (e.g., copper, brass, and etc.) were found to be suitable for bolt-through type power connector 140. It was found that these materials do not overheat when a relatively high amperage level (e.g., 450 amperes or more) is applied to bolt-through type power connector 140. In addition, these materials are relatively safe and reliable in relatively high amperage conditions, such as that associated with welding outputs of 450 amperes or above.

Referring generally to FIGS. 4A and 4B, cross-section views of bolt-through type power connector 140 before and after installation are illustrated according to one exemplary embodiment. Also, a perspective view of an exemplary embodiment of bolt-though type power connector 140 after installation is illustrated in FIG. 2 on a left-hand side of modular access panel 130. As shown, bolt-through type power connector 140 is sized such that it is longer than bulkhead assembly 150. The sizing of bolt-through type power connector 140 is such that power cable connection portion 140A extends out from bulkhead assembly 150 and is easily accessible. This extension from the bulkhead assembly 150 and the modular access panel 130 makes it easy to quickly connect or disconnect one or more power cables 100 to the bolt-through type power connector 140. The sizing of bolt-through type power connector 140 is such that attachment portion 140B extends out from bulkhead assembly 150 to accommodate mounting hardware 160 and voltage sense tab 163.

Mounting hardware 160 is configured to securely mount and fasten bolt-through type power connector 140 to bulkhead assembly 150 and modular access panel 130. Mounting hardware 160 may include one or more of various types of fasteners and any of their related pieces. As examples, mounting hardware 160 may include one or more of various types of fasteners, bolts, nuts, screws, washers, or other similar mechanical elements. In the illustrated embodiment, mounting hardware 160 includes an internal-tooth type washer 161, a nut 162 (before voltage sense tab 163), a nut 164 (after voltage sense tab 163), and a bolt 165.

Voltage sense tab 163 is configured to enable voltage or voltage related feedback and/or information to be read or sensed at its location. Voltage sense tab 163 may be a standard element, as is known in the art.

Further information regarding applications of these components follows below. The description below provides illustrative examples that highlight the interchangeability of the power connectors. The interchangeability of the power connectors enables the current capabilities to be changed without also having to change the modular access panel 130 and the bulkhead assembly 150. That is, the systems and methods described herein allow the same modular access panel 130 and the same bulkhead assembly 150 to be compatible with twist-lock type power connector 170 in one instance and compatible with bolt-through type power connector 140 in another instance.

Referring generally to FIG. 5, modular access panel 130 and bulkhead assembly 150 are illustrated together with twist-lock type power connector 170 according to one exemplary embodiment. As shown, bulkhead assembly 150 may be securely mounted on modular access panel 130. In addition, bulkhead assembly 150 has a power connector receiving portion with a profile that is configured to mate with twist-lock type power connector 170, particularly a DINSE® connector. More specifically, bulkhead assembly 150 has a profile that is structured to mate with cable socket part of the DINSE® connector. That is, bulkhead assembly 150 has a female mating profile while cable socket part has a male mating profile. When the cable socket part is installed in bulkhead assembly 150, the cable plug part of the DINSE® connector with its single power cable 110 may connect to power source 120 via the cable socket part of the DINSE® connector. With such a connection, as discussed above, welding system 100 is configured to provide an output of 450 amperes or less.

Referring generally to FIGS. 6A-6B and FIGS. 7A-7B, modular access panel 130 and bulkhead assembly 150 are illustrated together with bolt-through type power connector 140 according to one exemplary embodiment. As shown in each of FIGS. 6A-6B and FIGS. 7A-7B, modular access panel 130 and bulkhead assembly 150 are the same as that which was illustrated in FIG. 5.

In FIGS. 6A and 6B, bolt-through type power connector 140 is illustrated with a single power cable 110 according to one exemplary embodiment. As shown, bolt-through type power connector 140 has a through hole 140C₁, which is structured to receive a mechanical fastener, such as bolt 141 and nut 142. Bolt 141 and nut 142 are configured to support a single power cable 110 via its ring terminal. Power cable 110 may be positioned on one side of the metal plate of the power cable connection portion 140A. Bolt-through type power connector 140 connects this power cable 110 to power source 120 of welding system 100. Power source 120 may be connected to bolt-through type power connector 140 via at least one electrical conductor 112 such as a bus bar, a power cable, any suitable power transmission means, or a combination thereof. In this regard, for example, the at least one electrical conductor 112 may be attached to a rear side of bolt-through type power connector 140 with a mechanical fastener, such as bolt 165. With this configuration, bolt-through type power connector 140 is configured to provide a connection that supports an output of 450 amperes or less.

In FIGS. 7A and 7B, bolt-through type power connector 140 is illustrated with a plurality of power cables 110 according to one exemplary embodiment. As shown, bolt-through type power connector 140 has a through hole 140C₁, which is structured to receive a mechanical fastener, such as bolt 141 and nut 142. Bolt 141 and nut 142 are configured to support a plurality of power cables 110 via their ring terminals. The plurality of power cables 110 may be two or more power cables. As shown, in this example, bolt-through type power connector 140 is configured to support at least two power cables 110. The two power cables 110 may be supported by the bolt 141 and nut 142 in relation to the bolt-through type power connector 140 in a number of different ways. As one example, one of the two power cables 110 may be connected to a first side of the metal plate of the power cable connection portion 140A. The other of the two power cables 110 may be connected to a second side of the metal plate of the power cable connection portion 140A. As shown, the metal plate is positioned between the two ring terminals of the power cables 110. Bolt 141 is inserted through the through hole 140C₁ of the power cable connection portion 140A and the ring terminals of the two power cables 110. In addition, nut 142 fastens the ring terminals to the bolt 141. In this case, bolt-through type power connector 140 connects each of the two power cables 110 to power source 120 of welding system 100. Power source 120 may be connected to bolt-through type power connector 140 via at least one electrical conductor 112 such as a bus bar, a power cable, any suitable power transmission means, or a combination thereof. In this regard, for example, the at least one electrical conductor 112 may be attached to a rear side of bolt-through type power connector 140 with a mechanical fastener, such as bolt 165. With this configuration, bolt-through type power connector 140 is configured to provide a connection that supports an output of 450 amperes or more.

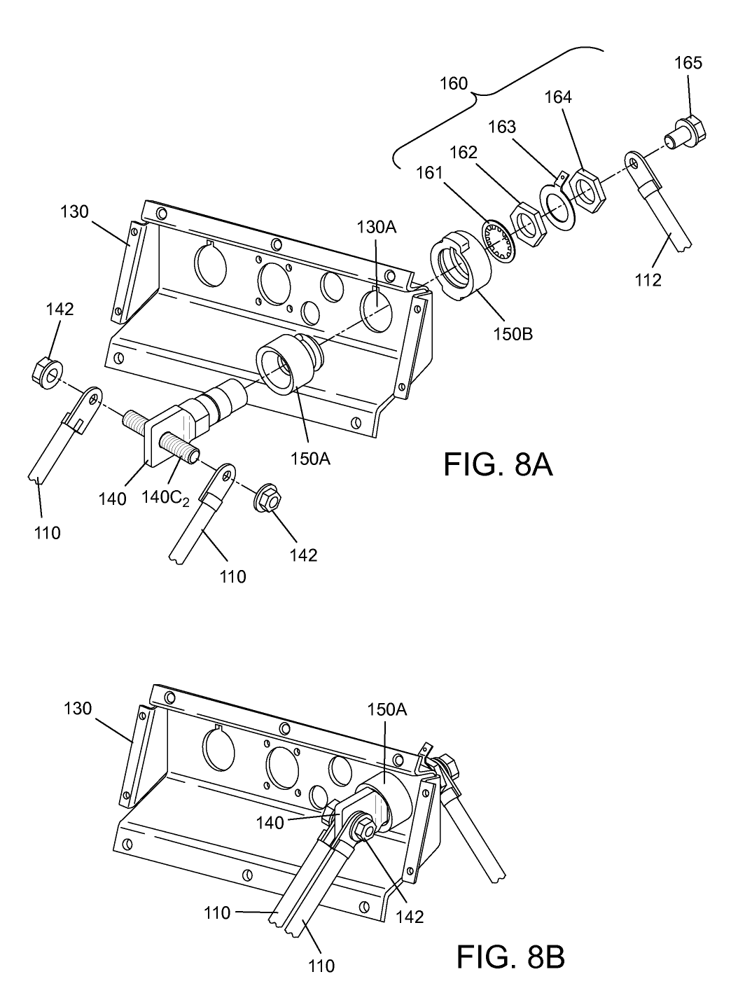

Referring generally to FIGS. 8A-8B, modular access panel 130 and bulkhead assembly 150 are illustrated together with bolt-through type power connector 140 according to one exemplary embodiment. As shown in each of FIGS. 8A-8B, modular access panel 130 and bulkhead assembly 150 are the same as that which was illustrated in FIGS. 5-7B.

More specifically, in FIGS. 8A and 8B, bolt-through type power connector 140 is illustrated with a plurality of power cables 110 according to one exemplary embodiment. As shown, bolt-through type power connector 140 includes stud 140C₂, which is structured to support one or more ring terminals of one or more power cables 110. The plurality of power cables 110 may be two or more power cables. As shown, in this example, bolt-through type power connector 140 is configured to support at least two power cables 110. The two power cables 110 may be supported by stud 140C₂ of the bolt-through type power connector 140 in a number of different ways. As one example, one of the two power cables 110 may be connected to a first side of the metal plate of the power cable connection portion 140A. The other of the two power cables 110 may be connected to a second side of the metal plate of the power cable connection portion 140A. As shown, the metal plate is positioned between the two ring terminals of the power cables 110. Stud 140C₂ is structured to support the ring terminals of the two power cables 110. In addition, each nut 142 fastens a respective ring terminal to the stud 140C₂. In this case, bolt-through type power connector 140 connects each of the two power cables 110 to power source 120 of welding system 100. Power source 120 may be connected to bolt-through type power connector 140 via at least one electrical conductor 112 such as a bus bar, a power cable, any suitable power transmission means, or a combination thereof. In this regard, for example, the at least one electrical conductor 112 may be attached to a rear side of bolt-through type power connector 140 with a mechanical fastener, such as bolt 165. With this configuration, bolt-through type power connector 140 is configured to provide a connection that supports an output of 450 amperes or more.

As discussed above, bolt-through type power connector 140 is structured to support a plurality of electrical configurations and current capabilities. Similarly to the twist-lock type power connector 170, bolt-through type power connector 140 is structured to support a connection to a single power cable 110 while enabling a current less than 450 amperes to be output for use by the welding system 100. However, unlike twist-lock type power connector 170, bolt-through type power connector 140 is structured to support a connection to a plurality of power cables 110. This enables a current equal to or greater than 450 amperes to be output for use by the welding system 100.

The systems and methods described herein also provide a number of other advantages. For example, from at least a manufacturing standpoint, an advantageous feature of the bolt-through type power connector 140 is its compatibility with the same modular access panel 130 and bulkhead assembly 150, which are structured to support twist-lock type power connector 170. This compatibility allows for a commonality of parts (e.g., modular access panel 130 and bulkhead assembly 150) in welding system 100 for bolt-through type power connector 140 and twist-lock type power connector 170. In effect, this reduces the number of different parts that need to be manufactured in association with these different types of power connectors.

Also, due to the interchangeability of these different types of power connectors, modular access panel 130 and bulkhead assembly 150 are not limited to one of these power connectors. In this regard, for example, various combinations and permutations can be made with regard to the interchangeability of these power connectors in relation to modular access panel 130 and bulkhead assembly 150. For example, one bolt-through type power connector 140 may be replaced with another bolt-through type power connector 140 in a given bulkhead assembly 150 of modular access panel 130. As another option, bolt-through type power connector 140 may be switched to twist-lock type power connector 170 in a given bulkhead assembly 150 of modular access panel 130. As another example, one twist-lock type power connector 170 may be replaced with another twist-lock type power connector 170 in a given bulkhead assembly 150 of modular access panel 130. Also, twist-lock type power connector 170 may be switched to bolt-through type power connector 140 in a given bulkhead assembly 150 of modular access panel 130. As discussed, the systems and methods described herein provide interchangeability, as well as increased design flexibility.

Furthermore, by enabling the same modular access panel 130 to be utilized, welding systems, such as the Continuum® line of products, are able to have a common look and feel irrespective of whether they include bolt-through type power connector 140 or twist-lock type power connector 170. This provides the added benefit of a familiar user experience.

The embodiments described above are intended to be exemplary. One skilled in the art recognizes that numerous alternative components and embodiments that may be substituted for or included in the particular examples described herein and such additions or substitutions still fall within the scope of the invention.

What is claimed is:

1. A bolt-through type power connector with first and second ends and comprising:
a metal plate portion at the first end with a structure configured to support one or more ring terminals of one or more power cables, the structure being (a) a through hole sized to receive a bolt that is structured to support the one or more ring terminals or (b) a stud that is structured to support the one or more ring terminals,
a metal attachment portion extending from the metal plate portion to the second end, the metal attachment portion having a male engagement portion with a flange portion that provides a surface facing the second end and an outer profile for receipt of hardware to secure the bolt-through type power connector within an opening of a bulkhead assembly,
wherein,
the bolt-through type power connector is structured to effectively carry a current that is equal to or greater than 450 amperes.

2. The bolt-through type power connector according to claim 1, wherein at least a portion of the bolt-through type power connector includes an anti-rotational structure such that the bolt-through type power connector does not rotate within the bulkhead assembly.

3. The bolt-through type power connector according to claim 1, wherein a cross section of a portion of the bolt-through type power connector comprises (a) a shape that is substantially circular with two oppositely facing flat sides or (b) a hexagonal shape.

4. The bolt-through type power connector according to claim 1, wherein:
the bulkhead assembly comprises a front insulator bulkhead and a rear insulator bulkhead, and
the bulkhead assembly has an inner profile with a female engagement portion that is structured to mate with a twist-lock type power connector.

5. The bolt-through type power connector according to claim 1, wherein the bolt-through type power connector comprises non-ferrous metal.

6. The bolt-through type power connector according to claim 1, wherein the bolt-through type power connector comprises brass, copper, or aluminum.

7. The bolt-through type power connector according to claim 1, wherein the metal plate portion and the metal attachment portion are a unitary body.

8. A modular access panel having a mounting plate, the modular access panel comprising:
a bulkhead assembly mounted on the mounting plate; and
a bolt-through type power connector inserted in the bulkhead assembly, the bolt-through type power connector having first and second ends and including
(i) a metal plate portion at the first end with a structure configured to support one or more ring terminals of one or more power cables, the structure being (a) a through hole sized to receive a bolt that is structured to support the one or more ring terminals or (b) a stud that is structured to support the one or more ring terminals,
(ii) a metal attachment portion extending from the metal plate portion to the second end, the metal attachment portion having a male engagement portion with a flange portion that provides a surface facing the second end and an outer profile for receipt of hardware to secure the bolt-through type power connector within an opening of the bulkhead assembly,
wherein,
the bolt-through type power connector is structured to effectively carry a current that is equal to or greater than 450 amperes.

9. The modular access panel according to claim 8, wherein a cross section of a portion of the bolt-through type power connector comprises (a) a shape that is substantially circular with two oppositely facing flat sides or (b) a hexagonal shape.

10. The modular access panel according to claim 8, wherein:
the metal plate portion extends out from the bulkhead assembly, and
the metal plate portion is wider than the metal attachment portion.

11. The modular access panel according to claim 8, wherein:
the bulkhead assembly comprises a front insulator bulkhead and a rear insulator bulkhead, and
the bulkhead assembly has an inner profile with a female engagement portion that is structured to mate with a twist-lock type power connector.

12. The modular access panel according to claim 8, wherein the bolt-through type power connector comprises non-ferrous metal.

13. The modular access panel according to claim 8, wherein the bolt-through type power connector comprises brass, copper, or aluminum.

14. The modular access panel according to claim 8, wherein the metal plate portion and the metal attachment portion are a unitary body.

15. A welding system comprising:
a power source;
a modular access panel having a mounting plate;
a bulkhead assembly mounted on the mounting plate; and
a bolt-through type power connector inserted in the bulkhead assembly and connected to the power source, the bolt-through type power connector having first and second ends and including
(i) a metal plate portion at the first end with a structure configured to support one or more ring terminals of one or more power cables, the structure being (a) a through hole sized to receive a bolt that is structured to support the one or more ring terminals or (b) a stud that is structured to support the one or more ring terminals,
(ii) a metal attachment portion extending from the metal plate portion to the second end, the metal attachment portion having a male engagement portion with a flange portion that provides a surface facing the second end and an outer profile for receipt of hardware to secure the bolt-through type power connector within an opening of a bulkhead assembly,
wherein,
the bolt-through type power connector is structured to effectively carry a current that is equal to or greater than 450 amperes.

16. The welding system of claim 15, wherein a cross section of a portion of the bolt-through type power connector comprises (a) a shape that is substantially circular with two oppositely facing flat sides or (b) a hexagonal shape.

17. The welding system according to claim 15, wherein:
the bulkhead assembly comprises a front insulator bulkhead and a rear insulator bulkhead, and
the bulkhead assembly has an inner profile with a female engagement portion that is structured to mate with a twist-lock type power connector.

18. The welding system according to claim 15, wherein the bolt-through type power connector comprises non-ferrous metal.

19. The welding system according to claim 15, wherein the bolt-through type power connector comprises brass, copper, or aluminum.

20. The welding system according to claim 15, wherein the metal plate portion and the metal attachment portion are a unitary body.
